(19) United States
(12) Patent Application Publication
(10) Pub. No.: US 2005/0246803 A1
(43) Pub. Date: Nov. 3, 2005

(54) Peripheral device for processing data from a computing device

(76) Inventor: Andrew M. Spencer, Eagle, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/835,719

(22) Filed: Apr. 30, 2004

(51) Int. Cl. G06F 3/00

(52) U.S. Cl. D18/1

(57) ABSTRACT

A system comprises a computing device and a peripheral device. The peripheral device is communicatively coupled to the computing device, and has a processor to process a primary functionality of the peripheral device. The peripheral device receives at least one of data and commands from the computing device for processing by the processor to perform functionality on the at least one of data and commands unrelated to the primary functionality of the peripheral device.

### BACKGROUND

Peripheral devices provide computing devices with additional functionality. Common peripheral devices include printing devices, such as inkjet and laser printers, storage devices, such as internal and external hard disk drives, and display devices, such as cathode-ray tube (CRT) displays and flat panel displays (FPD's). A peripheral device generally has a primary functionality, such as printing data in the case of a printing device, storing data in the case of a storage device, and displaying data in the case of a display device.

Historically, peripheral devices did not have processors, such as central-processing units (CPU's). Instead, the computing device performed processing for the peripheral device. For example, in the case of a printing device, the conversion of image data desired to be printed by a user into data understandable by the printing device was completely accomplished by the computing device to which the printing device was connected. The printing device could not perform such data conversion in order to perform its primary functionality.

Now, peripheral devices include processors that process data for the primary functionality of their peripheral devices. As such, computing devices are not required to perform processing for the peripheral devices. For example, in the case of a printing device, a computing device may simply provide the image data desired to be printed to the printing device, and the printing device itself converts the image data as needed. Because most peripheral devices perform their primary functionalities for just a small portion of the time, their processors are not being efficiently used.

### BRIEF DESCRIPTION OF THE DRAWINGS

Features shown in the drawing are meant as illustrative of only some embodiments of the invention, and not of all embodiments of the invention.

FIG. 1 is a block diagram of a system including a computing device and a peripheral device having at least a processor, according to an embodiment of the invention.

FIG. 2 is a block diagram of a peripheral device having at least a processor and an interface, according to an embodiment of the invention.

FIG. 3 is a block diagram of a peripheral device having at least a processor and a storage mechanism, according to an embodiment of the invention.

FIG. 4 is a block diagram of a peripheral device having at least a processor and a storage mechanism, according to another embodiment of the invention.

FIG. 5 is a method of use for a peripheral device having at least a processor, according to an embodiment of the invention.

### DETAILED DESCRIPTION

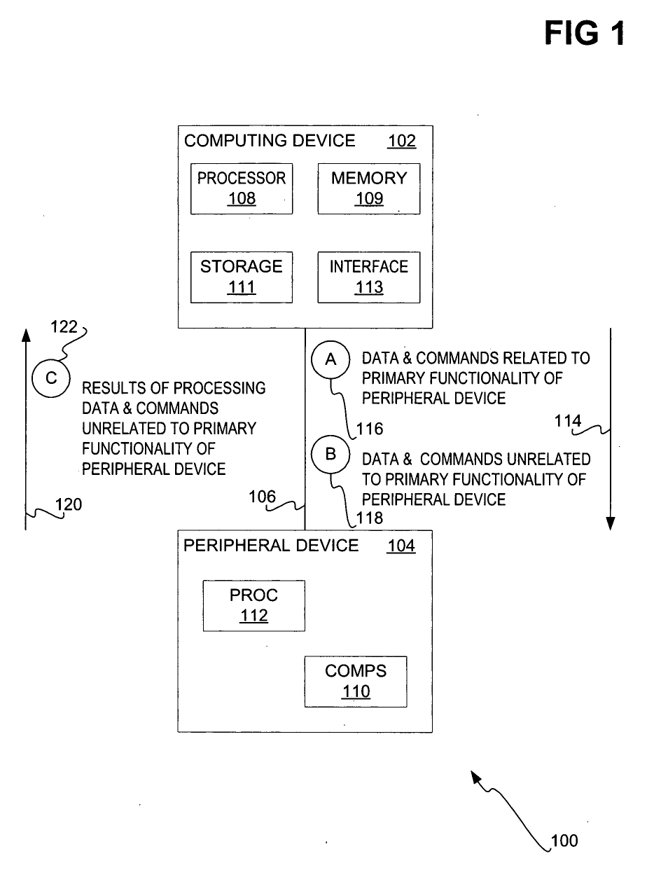

FIG. 1 shows a system 100, according to an embodiment of the invention. The system 100 includes a computing device 102 and a peripheral device 104. The computing device 102 may be a computer, such as a desktop computer, a laptop computer, a handheld computer, a personal digital assistance (PDA) device, a wireless or landline phone, or another type of computing device. The peripheral device 104 is a hardware device that is communicatively connected to the computing device 102, as indicated by the line 106, to provide the computing device 102 with processing assistance and additional functionality. For example, the peripheral device 104 may be a printing device, such as an inkjet or a laser printer, a storage device, such as an internal or an external hard disk drive or a memory card, a display device, such as a cathode-ray tube (CRT) display or a flat-panel display (FPD), a scanner device, a personal digital assistant (PDA) device, a digital camera device, or another type of peripheral device. The communicative connection between the peripheral device 104 and the computing device 102, as indicated by the line 106, may be a wired connection, a wireless connection, a connection over a network, and so on.

The computing device 102 includes at least a processor 108, memory 109, storage 111, and an interface 113. The processor 108 processes data and commands, such as by executing computer-executable instructions of computer programs with respect to the data and commands or by performing other types of processing tasks. The memory 109 may be volatile semiconductor memory, and thus temporarily store data and commands. The storage 111 may be non-volatile storage, such as a hard disk drive, and thus indefinitely store data and commands. The interface 113 enables the computing device 102 to communicate with peripheral devices like the peripheral device 104, and may be a wired or a wireless interface. The computing device 102 may include components in addition to the processor 108, the memory 109, the storage 111, and the interface 113.

The peripheral device 104 includes at least one or more components 110 and a processor 112; in one embodiment, the processor 112 may be part of one of the components 110. The components 110 are the components needed by the peripheral device 104 to provide the primary functionality of the peripheral device 104. For example, if the peripheral device 104 is a printing device like a laser printer, the components 110 may include the fuser, laser, media-storage trays, and the other components for the peripheral device 104 to provide its primary functionality, which is laser printing.

The processor 112 of the peripheral device 104 processes data and commands received from the computing device 102 that are related to the primary functionality of the peripheral device 104, as indicated by the arrow 114. Such data and commands related to the primary functionality of the peripheral device 104 are indicated by the letter A 116 in FIG. 1. An example of the data indicated by the letter A 116, where the peripheral device 104 is a laser printer or other type of printing device, is a text or image file that a user of the computing device 102 wishes to output onto media via the peripheral device 104. The processor 112 of the peripheral device 104 converts the text or image file into data that the components 110 are able to process. The components 110 can then use this data to output the text or image file onto media. An example of a command indicated by the letter A 116 is a command to configure the printer to output the text or image file onto media in a reduced-toner-usage mode. The processor 112 of the peripheral device 104 thus processes the data and commands indicated by the letter A 116 in order to assist the components 110 in providing the primary functionality of the peripheral device 104.

The processor 112 of the peripheral device 104 also processes data and commands received from the computing device 102 that are unrelated to the primary functionality of the peripheral device 104, as indicated by the arrow 114. Such data and commands unrelated to the primary functionality of the peripheral device 104 are indicated by the letter B 118 in FIG. 1. For example, a decryption command may preface data that is received after the decryption command is received, in which case the decryption command indicates that decryption is to be performed on or relative to data that is to be received.

For instance, the computing device 102 communicates with the peripheral device 104 by sending data that the peripheral device 104 is to decrypt, and by sending the decryption command to the peripheral device 104. The computing device 102 may send the data and the command within a predefined protocol that is otherwise employed by the computing device 102 to send primary functionality data and commands to the peripheral device 104. Alternatively, the computing device 102 may send the data and the command in accordance with a protocol especially tailored for transmission of data and commands that do not relate to the primary functionality of the peripheral device 104. As another example, the command may indicate to the peripheral device 104 to have its processor 112 execute or process code, such as a computer program that has been transferred from the computing device 102 to the peripheral device 104.

Once the processor 112 of the peripheral device 104 processes the data and commands indicated by the letter B 118, the computing device 102 receives results of the processing of this data and commands from the peripheral device 104, as indicated by the arrow 120. The results of the processing of the data and commands unrelated to the primary functionality of the peripheral device are indicated by the letter C 122 in FIG. 1. The computing device 102 being able to send data and commands unrelated to the primary functionality of the peripheral device 104 for processing by the processor 112 of the peripheral device 104 means that the computing device 102 is able to transfer processing tasks to the peripheral device 104. The peripheral device 104 can thus assist the computing device 102 in performing processing tasks that traditionally have been performed only by the computing device 102.

Processing tasks of the computing device 102 may thus be distributed between its processor 108 and the processor 112 of the peripheral device 104. Transferring processing tasks to the peripheral device 104 effectively increasing the amount of processing power available to the computing device 102. That is, when the peripheral device 104 is not actively using its processor 112, the processor 112 becomes available for the computing device 102 to use. As such, the computing device 102 has two processors at its disposal, its own processor 108, as well as the processor 112 of the peripheral device 104. In this way, the computing device 102 leverages the processor 112 of the peripheral device 104 when it is not being used to assist the peripheral device 104's primary functionality.

For example, the peripheral device 104 may be a laser printer or another type of printing device. As a result, the processor 112 is able to process the data and commands related to the primary functionality of the peripheral device 104, which is printing print jobs submitted by the computing device 102, as may be indicated by the letter A 116. The computing device 102 may, besides sending the peripheral device 104 such print jobs, also send the peripheral device 104 data and commands unrelated to printing, as indicated by the letter B 118. For example, the data unrelated to printing may be data that is to be encrypted. The command unrelated to printing may be an indication that the data is to be encrypted, as opposed to, for instance, decrypted. The computing device may have already transferred the encryption algorithm to the peripheral device 104. When the processor 112 is not actively processing a print job or other data related to the primary functionality of the peripheral device 104, the processor 112 processes the data unrelated to printing, such as specifically encrypting this data. Once the peripheral device 104 has encrypted the data unrelated to its primary functionality, the peripheral device 104 returns the encrypted data, as may be indicated by the letter C 122, back to the computing device 102.

In the example of the previous paragraph, the primary functionality of the peripheral device 104 is printing print jobs submitted by the computing device 102. However, the processor 112 of the peripheral device 104 also processes data and commands that are unrelated to the primary functionality of the peripheral device 104. The encryption of data by the processor 112 is unrelated to the primary functionality of the peripheral device 104. If the processor 112 is not currently processing data and commands related to printing, the processor 112 can instead process data and commands unrelated to printing, such as encrypting data. The computing device 102 thus offloads some processing tasks onto the processor 112 that would otherwise have to be completely performed by the processor 108 of the computing device 102. As such, the computing device 102 leverages the processing capability of the processor 112 of the peripheral device 104. Other functionality of the peripheral device 104 may include decompression, encryption, and decryption.

As noted, the processor 112 of the peripheral device 104 can perform processing tasks for the computing device 102. Such processing tasks are not limited to the examples of encryption and decryption. The computing device 102 can request the peripheral device 104 to perform a wide variety of tasks, such as processing and/or storing data, commands, instructions, code, programs, and so on.

As another example, the peripheral device 104 may be a tape drive or another type of storage device. The primary functionality of the tape drive may be to store archived data submitted by the computing device 102, as may be indicated by the letter A 116. As part of the primary functionality of the peripheral device 104, the processor 112 may first automatically compress the archived data before storing it on tape media represented by the components 110. The processor 112 may also be able to receive data and commands that are unrelated to the primary functionality of the peripheral device 104, such as data and commands indicated by the letter B 118 that is not intended for storage. The processor 112 may nevertheless compress this data, in accordance with a command that specifies compression of the data. The processor 112 thus performs functionality unrelated to the primary functionality of the peripheral device 104, which is storing data. After compressing the data, the peripheral device 104 sends the compressed data back to the computing device 102, as may be indicated by the letter C 122. The computing device 102 is therefore able to employ the compression functionality of the peripheral device 104 on data that is not intended to be stored on the peripheral device 104.

As a final example, the peripheral device 104 may be a flat-panel display (FPD), or another type of display device. The primary functionality of the FPD is to display image data submitted by the computing device 102. The processor 112 may process the image data, as may be indicated by the letter A 116, prior to displaying on the display elements of the FPD represented by the components 110. The processor 112 may also be able to process other data and commands submitted by the computing device 102, as may be indicated by the letter B 118, and send back the results of such processing to the computing device 102, as may be indicated by the letter C 122.

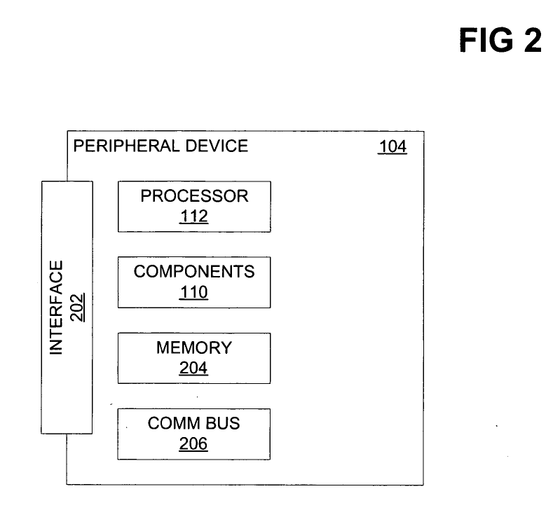

FIG. 2 shows the peripheral device 104 of FIG. 1 in more detail, according to an embodiment of the invention. The peripheral device 104 is depicted in FIG. 2 as including an interface 202, memory 204, and a communication bus 206, in addition to the one or more components 1.10 and the processor 112. The memory 204 may be volatile semiconductor memory, enabling the peripheral device 104 to temporarily store data and commands received from the computing device 102. The communication bus 206 may communicatively connect the processor 112, the components 110, the memory 204, and the interface 202.

The interface 202 may be implemented in accordance with various embodiments of the invention to allow the computing device 102 to communicate with the peripheral device 104. For example, the interface may be a wired interface or a wireless interface. As a wired interface, the interface 202 may be one or both of two types of interfaces. As one example, the interface 202 may be a hardware-oriented interface. As such, the interface 202 may include one or more pins, or leads or conductors. Such pins, leads and/or conductors are intended for the computing device 102 of FIG. 1 to send data and commands, either data and commands related to the primary functionality of the peripheral device 104, or data and commands unrelated to the primary functionality of the peripheral device 104.

The interface 202 may further include additional pins, leads and/or conductors. Such additional pins, leads, and/or conductors are asserted or unasserted by the computing device 102 to indicate whether the information being transmitted is information related to the primary functionality of the peripheral device 104, or information unrelated to the primary functionality of the peripheral device 104. The processor 112 may further return the results of the processing of the data or command unrelated to the primary functionality of the peripheral device 104 over the interface 202.

As another example, the interface 202 may be a software-oriented interface. As such, the interface 202 may define a communication protocol by which the peripheral device 104 receives from the computing device 102 data or a command either related to or unrelated to the primary functionality of the peripheral device 104. The interface 202 may further define a communication protocol to indicate whether the data or command is related to or unrelated to the primary functionality of the peripheral device 104. Furthermore, the interface 202 may define a communication protocol by which the processor 112 may return the results of the processing of the data or command unrelated to the primary functionality of the peripheral device 104. For example, the communication protocol may packetize data, where each packet of data includes a header that indicates the type of data being transmitted, as well as the actual data being transmitted.

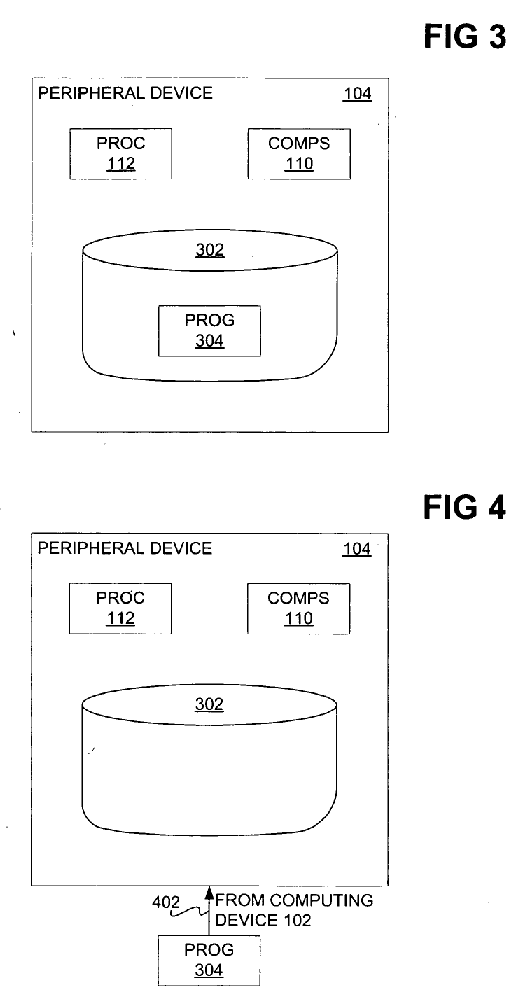

FIG. 3 shows the peripheral device 104, according to another embodiment of the invention. The peripheral device 104 is depicted in FIG. 3 as including a storage mechanism 302 storing a computer program 304. The peripheral device 104 also includes, as before, the one or more components 110 and the processor 112. The peripheral device 104 may further include the interface 202 of FIG. 2 in one embodiment. The storage mechanism 302 may be non-volatile memory, such as a semiconductor flash memory, or a magnetic medium, such as a hard disk drive, or another type of storage mechanism.

The computer program 304, when executed by the processor 112 on data or commands received from the computing device 102 of FIG. 1, processes the data or commands in accordance with functionality unrelated to the primary functionality of the peripheral device 104. For example, the computer program 304 may encrypt and decrypt data. The data or commands received from the computing device 102 may further be stored on the storage mechanism 302, and the results of the processing of the data or commands by the computer program 304 may be stored on the storage mechanism 302 and retrieved from the storage mechanism 302 by the computing device 102.

The functionality unrelated to the primary functionality of the peripheral device 104 may thus be predetermined functionality implemented as the computer program 304. The computing device may not be able to modify or change the computer program 304. As a result, even though the computing device 102 may know what additional functionality the peripheral device 104 can perform, the computing device 102 may not be able to change that additional functionality, because it is not able to modify or change the computer program 304.

FIG. 4 shows the peripheral device 104, according to another embodiment of the invention. The peripheral device 104 is depicted in FIG. 4 as including a storage mechanism 302. The peripheral device 104 also includes, as before, the one or more components 110 and the processor 112. The peripheral device 104 may further include the interface 202 of FIG. 2 in one embodiment. Similar to the embodiment of FIG. 3, the storage mechanism 302 in the embodiment of FIG. 4 may be non-volatile memory, a magnetic medium, or another type of storage mechanism, as well as volatile memory, such as dynamic random-access memory (DRAM).

In the embodiment of FIG. 4, the computer program 304 is received from the computing device 102 of FIG. 1, as indicated by the arrow 402. The computer program 304, upon being received by the peripheral device 104, may be stored in the storage mechanism 302. Because the computer program 304 is received from the computing device 102, the functionality unrelated to the primary functionality of the peripheral device 104 is non-predetermined functionality. That is, the computing program 102, via the computer program 304, determines the functionality unrelated to the primary functionality of the peripheral device 104. The processor 112 processes information received from the computing device 102 that is unrelated to the primary functionality of the peripheral device 104. The processor 112 processes the information by executing the computer program 304, and then may store the results of the processing on the storage mechanism 302 for retrieval by the computing device 102. In both the embodiments of FIGS. 3 and 4, the term computer program is meant to be construed broadly, and encompasses computer-executable instructions, modules, objects, codes, and other types computer-executable entities.

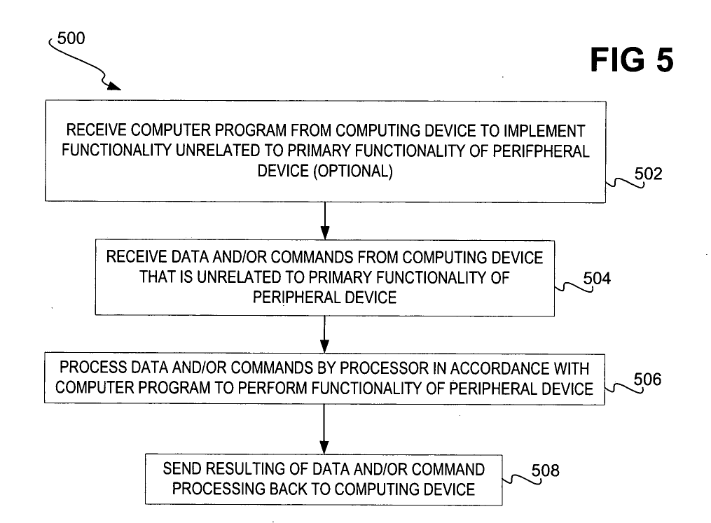

FIG. 5 shows a method of use 500 that may be performed by the peripheral device 104, according to an embodiment of the invention. The peripheral device 104 may optionally receive the computer program 304 from the computing device 102 (502). The computer program 304 implements functionality unrelated to the primary functionality of the peripheral device 104. When the peripheral device 104 receives the computer program 304, the method 500 operates consistently with the embodiment described in relation to FIG. 4, in which the computing device 102 controls the additional functionality unrelated to the primary functionality of the peripheral device 104. Otherwise, the method 500 operates consistently with the embodiment described in relation to FIG. 3, in which the computer program 304 is pre-stored on the storage mechanism 302 and the functionality unrelated to the primary functionality of the peripheral device 104 is predetermined.

The peripheral device 104 next receives data and/or commands from the computing device 102 (504). The data and/or commands are meant for processing in relation to the functionality unrelated to the primary functionality of the peripheral device 104. For example, the data and/or commands may be received over the interface 202 of FIG. 2, in one embodiment of the invention. As another example, the data and/or commands may be stored by the computing device 102 onto the storage mechanism 302 of FIG. 3 or FIG. 4, in another embodiment of the invention. In the case where 502 is performed, the computer program 304 may also be stored onto the storage mechanism 302.

The processor 112 of the peripheral device 104 processes the data and/or commands in accordance with the computer program 304 to perform the functionality on the data and/or commands (506). The functionality is unrelated to the primary functionality of the peripheral device 104. The peripheral device 104, such as the processor 112 thereof, then sends back the results of processing the data and/or commands to the computing device 102 (508). For example, the results of processing the data and/or commands may be sent via the interface 202 of FIG. 2, in one embodiment of the invention. As another example, the results of processing the data and/or commands may be stored onto the storage mechanism 302 of FIG. 3 or FIG. 4 that is accessible by the computing device 102 for retrieval, in another embodiment of the invention.

1. A system comprising:
a computing device; and,
a peripheral device communicatively coupled to the computing device and having a processor to process a primary functionality of the peripheral device,
wherein the peripheral device receives at least one of data and commands from the computing device for processing by the processor to perform functionality on the at least one of data and commands unrelated to the primary functionality of the peripheral device.

2. The system of claim 1, wherein the peripheral device receives computer programs from the computing device for execution by the processor of the peripheral device to perform the functionality on the at least one of data and commands unrelated to the primary functionality of the peripheral device.

3. The system of claim 1, wherein the computing device transfers processing tasks to the peripheral device, the processing tasks being unrelated to the primary functionality of the peripheral device.

4. The system of claim 1, wherein the computing device distributes processing tasks between a processor of the computing device and the processor of the peripheral device.

5. The system of claim 1, wherein the peripheral device is a printing device, the primary functionality of the peripheral device being printing print jobs submitted by the computing device, the peripheral device able to receive the at least one of data and commands from the computing device for processing by the processor of the peripheral device to perform the functionality on the at least one of data and commands unrelated to printing the print jobs.

6. The system of claim 1, wherein the peripheral device is a storage device, the primary functionality of the peripheral device being storing data submitted by the computing device, the peripheral device able to receive at least the data from the computing device for processing by the processor of the peripheral device to perform the functionality on the data unrelated to storing the archived data.

7. The system of claim 6, wherein the functionality on the data unrelated to storage performed by the processor of the peripheral device is at least one of: compression of the data; decompression of the data, encryption of the data, and decryption of the data.

8. The system of claim 1, wherein the peripheral device is a display device, the primary functionality of the peripheral device being displaying image data submitted by the computing device, the peripheral device able to receive the at least one of data and commands from the computing device for processing by the processor of the peripheral device to perform the functionality on the at least one of data and commands unrelated to displaying the image data.

9. A peripheral device comprising:
a processor for executing instructions received from a computing device to increase processing power available to the computing device, wherein the instructions are unrelated to a primary functionality of the peripheral device; and,
a storage mechanism on which the computing device stores the data and commands, and from which the computing device retrieves results of processing the data and commands by the processor.

10. The peripheral device of claim 9, further comprising an interface for transferring data and commands to the computing device and for receiving data and commands from the computing device.

11. The peripheral device of claim 9, wherein the computing device also stores a computer program on the storage mechanism, the computer program being executed by the processor to execute the instructions unrelated to the primary functionality of the peripheral device.

12. The peripheral device of claim 9, wherein the storage mechanism also pre-stores a computer program that is executed by the processor to execute the instructions unrelated to the primary functionality of the peripheral device.

13. The peripheral device of claim 9, wherein the functionality unrelated to the primary functionality of the peripheral device is non-predetermined functionality and is determined via a computer program sent by the computing device to the peripheral device.

14. The peripheral device of claim 9, wherein the instructions unrelated to the primary functionality of the peripheral device is predetermined functionality implemented as a computer program stored at the peripheral device.

15. The peripheral device of claim 9, wherein the processor is to also receive a computer program from the computing device to execute the instructions unrelated to the primary functionality of the peripheral device.

16. The peripheral device of claim 9, wherein the peripheral device is one of: a printing device, a storage device, a scanner device, a personal digital assistant (PDA) device, a digital camera device, and a display device.

17. A peripheral device in communication with a computing device, the peripheral device comprising:
means for providing a primary functionality of the peripheral device for the computing device; and,
means for processing primary functionality data and commands received from the computing device and for processing additional data and commands received from the computing device to perform functionality unrelated to the primary functionality of the peripheral device for the computing device.

18. The peripheral device of claim 17, further comprising means for storing data and commands and a computer program, wherein the means for processing executes the computer program to process the additional data and commands to distribute processing tasks away from the computing device and to the means for processing.

19. A method comprising:
transferring data from a computing device to a peripheral device, the data being unrelated to primary functionality of the peripheral device;
processing the data by a processor of the peripheral device to increase available processing power of the computing device and to perform functionality on the data unrelated to the primary functionality of the peripheral device; and,
sending processed data from the peripheral device to the computing device.

20. The method of claim 19, further comprising transferring a computer program from the computing device to the peripheral device, executing the computer program by the peripheral device to process data for the computing device to further increase available processing power to the computing device.

21. The method of claim 19, wherein the data between the computing device and the peripheral device is transferred via wireless transmission.

22. The method of claim 19, further comprising storing, by the peripheral device, the data from the computing device.

23. The method of claim 19, wherein processing the data by the processor of the peripheral device comprises processing the data by the processor of the peripheral device with a computer program stored at the peripheral device.

24. The method of claim 19, wherein sending the processed data from the peripheral device to the computing device comprises sending the processed data from the peripheral device to the computing device over an interface of the peripheral device.

25. The method of claim 19, wherein sending the processed data from the peripheral device to the computing device comprises storing the data by the peripheral device at a storage location in the peripheral device, the storage location being accessible by the computing device.

26. A method comprising:
coupling a peripheral device to a remotely located computing device;
sending primary functionality data and commands from the computing device to the peripheral device, wherein the primary functionality data and commands relate to a primary functionality of the peripheral device;
distributing processing tasks from the computing device to the peripheral device by sending additional data and commands from the computing device to the peripheral device, wherein the additional data and commands are unrelated to the primary functionality of the peripheral device; and,
providing a processor of the peripheral device that is capable of processing primary functionality data and commands received from the computing device, and that is capable of processing the additional data and commands received from the computing device to decrease processing tasks designed for the computing device.

27. The method of claim 26, further comprising receiving, via an interface, the primary functionality data and commands and the additional data and commands, and sending, via the interface, results of processing the additional data and commands after having performed the functionality unrelated to the primary functionality of the peripheral device with respect to the additional data and commands.

28. The method of claim 26, further comprising storing, at the peripheral device, the additional data and commands.

29. The method of claim 28, further comprising storing, at the peripheral device, a computer program that is executable by the processor relative to the additional data and commands to perform the functionality unrelated to the primary functionality of the peripheral device.

30. The method of claim 26, wherein the peripheral device is one of: a printing device, a storage device, and a display device.
